(19) United States
(12) Patent Application Publication
(10) Pub. No.: US 2012/0303714 A1
(43) Pub. Date: Nov. 29, 2012

(54) METHOD FOR MANAGING A PERSONALIZED SOCIAL NETWORK MAP IN AN APPLICATION SERVER WHICH PROVIDES PERSONALIZED CONTENT, AND PROGRAM RECORDING MEDIUM FOR EXECUTING THE METHOD

(76) Inventors: Yun Seo Chung, Seoul (KR); Mi Peum Park, Seoul (KR)

(21) Appl. No.: 13/578,715

(22) PCT Filed: Nov. 1, 2010
(86) PCT No.: PCT/KR10/07614

§ 371 Date: Aug. 13, 2012

(30) Foreign Application Priority Data
Feb. 12, 2010 (KR) 10-2010-0013486

(51) Int. Cl. G06F 15/16

(52) U.S. Cl. 709/204

(57) ABSTRACT

The present invention relates to an application server for providing personalized content, which performs the steps of: detecting traffic for a first user of the application server to access content associated with a second user of the application server; determining an interest value of the first user in the second user based on the amount, type, or time of the detected traffic; and generating, for each user, a social network table including the interest value of the first user in the second user, so as to be applicable to various pieces of application content using interest values assigned among most personalized content users.

### TECHNICAL FIELD

The present invention relates to an application server that provides personalized content, and more particularly, to a personalized social network map management apparatus and method that provide interest values between users based on traffic to to give access to content associated with other users in real time in an application server that provides personalized content, and a program recording medium for executing the method.

### BACKGROUND ART

Recently, as the Internet technology has been developed, online subjects (hereinafter referred to as users) that pursue online mutual exchange through personalized content such as blogs, micro-blogs, or mini-homepages (hereinafter referred to as blogs) are rapidly increasing. Users of personalized content cross-link according to their interest or actively communicate with each other through comments, trackback, etc.

Meanwhile, in accordance with the small-world paradigm of “Kevin Bacon”, most users are connected to each other by very short distances at some steps. That is, a great coverage may be formed only by expanding a small number of steps (for example, six steps) from one user.

Therefore, an application server that provides personalized content indicates degrees of relations between users by using numerical values and records paths therebetween based on the above-described small-world paradigm, and thus there is a need to provide a social network map management apparatus and method capable of applying the relations to various pieces of application content, and a program recording medium for executing the method.

### DETAILED DESCRIPTION OF THE INVENTION

### Technical Problem

The present invention provides a personalized social network map management apparatus and method that record paths between most personalized content users, provide interest values indicating degrees of relations therebetween, and apply the paths and the interest values to various pieces of application content, based on traffic to give access to content associated with other users in real time and the small-world paradigm in an application server that provides personalized content, and a program recording medium for executing the method.

### Effect of the Invention

According to an embodiment of the present invention, based on traffic to give access to content associated with other users in real time in an application server that provides personalized content, interest values provided to most personalized content users can be applied to various pieces of application content.

### DESCRIPTION OF THE DRAWINGS

The above and other features and advantages of the present invention will become more apparent by describing in detail exemplary embodiments thereof with reference to the attached drawings in which:

FIG. 1 is a block diagram of a personalized social network map management apparatus in an application server that provides personalized content, according to an embodiment of the present invention;

FIG. 2 is a diagram for explaining an example of converting online activities of a user into interest values;

FIG. 3 is a diagram for explaining an example of changing interest values when an online activity of the user of FIG. 2 is added;

FIG. 4 is a diagram for explaining an example of changing interest values when an online activity with respect to another user of FIG. 3 is added;

FIG. 5 is a diagram for explaining an example of determining an estimated interest value from a first step interest value;

FIG. 6 is a diagram for explaining an example of adding a connection step number with respect to another user of FIG. 5;

FIG. 7 is a social network table generated by the personalized social network map management apparatus of FIG. 1;

FIG. 8 shows an example of a social network map including first step interest values for each user;

FIG. 9 shows an example of a personalized social network map including first step interest values and estimated interest values with respect to a specific user; and

FIG. 10 is a flowchart of a personalized social network map management method in an application server that provides personalized content, according to an embodiment of the present invention.

### TECHNICAL SOLUTION

According to an aspect of the present invention, there is provided a personalized social network map management method in an application server that provides personalized content, the method comprising: detecting traffic for a first user of the application server to access content associated with a second user of the application server; determining an interest value of the first user with respect to the second user based on the amount, type, or time of the detected traffic; and generating, for each user, a social network table including the interest value of the first user with respect to the second user.

According to another aspect of the present invention, there is provided a computer-readable recording medium storing a program for executing a personalized social network map management method in an application server that provides personalized content, the method comprising: detecting traffic for a first user of the application server to access content associated with a second user of the application server; determining an interest value of the first user with respect to the second user based on the amount, type, or time of the detected traffic; and generating, for each user, a social network table including the interest value of the first user with respect to the second user.

### MODE FOR INVENTION

Hereinafter, the present invention will be described in detail by explaining exemplary embodiments of the invention with reference to the attached drawings.

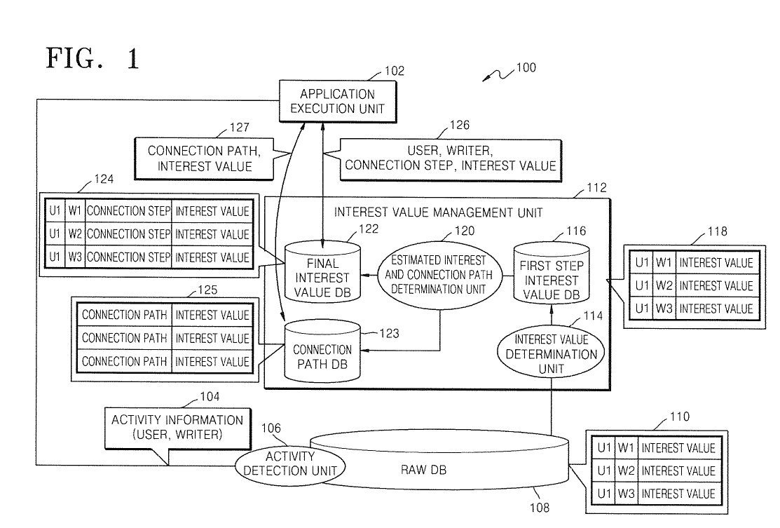

FIG. 1 is a block diagram of a personalized social network map management apparatus 100 in an application server that provides personalized content, according to an embodiment of the present invention.

Referring to FIG. 1, the personalized social network map management apparatus 100 is connected to computers (not shown) of users who use the personalized content over a network such as the Internet. Also, the personalized social network map to management apparatus 100 may be included in the application server that provides personalized content or may be included in a server other than the application server.

The personalized social network map management apparatus 100 is an apparatus for providing interest values (i-Value) indicating degrees of relations between a plurality of personalized content users and applying the interest values to various pieces of application content, based on traffic to give access to content associated with other users in real time and the small-world paradigm in the application server that provides personalized content.

In this regard, the interest values (i-Value) mean parameter values determined based on the amount, type, or time, etc. of online activity of a personalized content user (hereinafter referred to as a first user) with respect to another user (hereinafter referred to as a second user) who is a target of the online activity of the first user. For example, it is assumed that the first user clicks twice to visit a blog of the second user and clicks three times to visit a blog of a third user. In this case, interest values (i-Value) of the first user may be determined as, for example, 2/(2+3)=0.4 and 3/(2+3)=0.6 with respect to the second user and the third user, respectively.

To determine the interest values (i-Value), traffic must be detected for the first user's access to content associated with the second user. As long as the second user, who is a target of traffic, exists, traffic because of all online activities may be used to determine the interest values (i-Value). For example, traffic may occur due to online activities such as clicking, seeing documents, visiting, registering friends, deleting friends, chatting, emailing, calling, texting, browsing, adding or deleting favorites, commenting, recommending, passing, editing and sending, scrapping, forwarding, storing, printing content, sharing content, trackback, selecting, releasing, mouseover, referring or tapping of a touch screen terminal, and the like.

To perform the above-described operation, the personalized social network map management apparatus 100 may include an activity detection unit 106, a RAW DB 108, an interest value management unit 112, and may further include an application execution unit 102.

The application execution unit 102 is connected to computers (not shown) of a plurality of users who use the personalized content and executes an application that provides the personalized content. Also, the application execution unit 102 may respectively receive necessary information 126 and 127 from a final interest value DB 122 and a connection path DB 123 and use the information 126 and 127 to execute the application.

The activity detection unit 106 detects traffic that gives access to the content associated with another user (the second user) connected to the application execution unit 102 by one user (the first user) connected to the application execution unit 102 and acquires activity information 104. The activity information 104 includes information regarding the first user (User of FIG. 1) who triggers traffic and the second user (Writer of FIG. 1) who is the target of traffic, information regarding the amount of traffic, a type thereof (for example, clicking, seeing documents, commenting, etc.), or a time thereof (for example, 09:00, 13:00, 21:30, etc.)

The RAW DB 108 stores the activity information 104 detected by the activity detection unit 016. FIG. 1 shows an example of storing the activity information 104 in the form of a table 110. The table 110 includes activity information of a first user U1 who triggers traffic, second users W1, W2, and W3 who are targets of traffic, and other activity information descriptions.

The interest value management unit 112 includes an interest value determination unit 114, a first step interest value DB 116, an estimated interest and connection path determination unit 120, and a final interest value DB 122.

The interest value determination unit 114 determines interest values (i.e. first step interest values) of the first user with respect to the second users based on the amount of traffic, the type thereof, or the time thereof that is detected by the activity detection unit 106 and stored in the RAW DB 108. In this regard, the first step interest values refer to interest values provided between a user who triggers traffic and a user who is a target of traffic.

The first step interest value DB 116 stores the first step interest values determined by the interest value determination unit 114. FIG. 1 shows an example of a table 118 that stores the first step interest values. The table 118 includes first step interest values of the first user U1 with respect to the second users W1, W2, and W3.

The estimated interest and connection path determination unit 120 determines to estimated interest values of the first user with respect to third users and connection paths thereof. In this regard, third users refer to users linking to users (the second users) who are targets of traffic or users linking through users (fourth users) linking to the users (the second users) who are targets of traffic. Estimated interest values refer to estimated interest values provided between a user who triggers traffic and users who are not directly linked to the user.

The estimated interest and connection path determination unit 120 may determine the estimated interest values of the first user with respect to the third users by using the interest values of the first user with respect to the second users and interest values or estimated interest values of the second users with respect to third users of the application server. In other words, the second users and the third users may have direct connection relations by traffic that occurs between the second users and the third users or indirect connection relations to which the estimated interest values are provided.

Also, the estimated interest and connection path determination unit 120 determines a connection step number (for example, in a case of the first user->the second users->the third users, a second step) of the first user with respect to the third users and connection paths of the first user with respect to the third users (for example, the first user->the second users->, the third users).

The final interest value DB 122 stores the first step interest values received through the estimated interest and connection path determination unit 120, and the estimated interest values determined by the estimated interest and connection path determination unit 120. Also, the final interest value DB 122 may store the connection step number determined by the estimated interest and connection path determination unit 120. FIG. 1 shows an example of storing the first step interest values and the estimated interest values in a social network table 124.

The connection path DB 123 stores the first step interest values, the estimated interest values, and the connection paths received from the estimated interest and connection path determination unit 120. FIG. 1 shows an example of storing the connection paths in a connection path table 125. As another example, the connection path DB 123 may not be separated from the final interest value DB 122 but may be included in the final interest value DB 122.

In addition, in a case where other traffic is detected for the first user's access to content associated with the third users, the interest value determination unit 114 may further determine first step interest values of the first user with respect to the third user based on the amount of detected traffic, a type thereof, or a time thereof. The first step interest values of the first user with respect to the third users and estimated interest values thereof may be separated from each other.

The final interest value DB 122 provides the application execution unit 102 with the information 126 included in the social network table 124. The connection path DB 123 provides the application execution unit 102 with the information 127 included in the connection path table 125. The information 126 includes the first user User, the second or third user Writer, the connection step number, the interest values (the first step interest values and the estimated interest values). Also, the information 127 includes the connection paths from the first user User to the final user Writer, the interest values (the first step interest values), and the estimated interest values.

The application execution unit 102 executes various applications by using the information 126 received from the final interest value DB 122 and the information 127 received from the connection path DB 123. How to utilize applications will be described later.

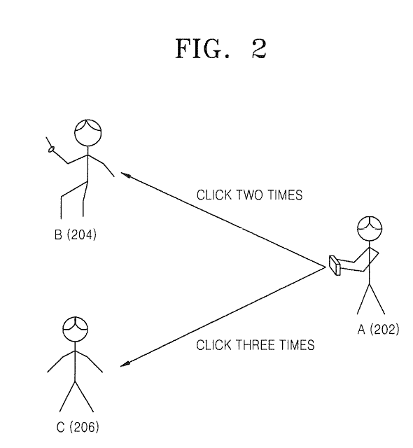

FIG. 2 is a diagram for explaining an example of converting online activities of a user into interest values.

Referring to FIG. 2, the personalized social network map management apparatus 100 counts a clicks number of a user A 202 and determines interest values with respect to users B 204 and C 206.

For example, when the total sum of interest values that the user A 202 may have for each connection step is 1, the personalized social network map management apparatus 100 may proportionally divide the total sum of interest values according to an activity amount with respect to respective targets that are the users B 204 and C 206 and determine interest values with respect to the respective targets B 204 and C 206.

For example, in a case where targets who the user A 202 is interested in are the users B 204 and C 206, since the numbers of activities (for example, clicks) done by the user A 202 with respect to the users B 204 and C 206 are two times and three times, respectively, an interest value of the user A 202 with respect to the user B 204 may be expressed as 2/(2+3)=0.4, and an interest value of the user A 202 with respect to the user C 206 may be expressed as 3/(2+3)=0.6.

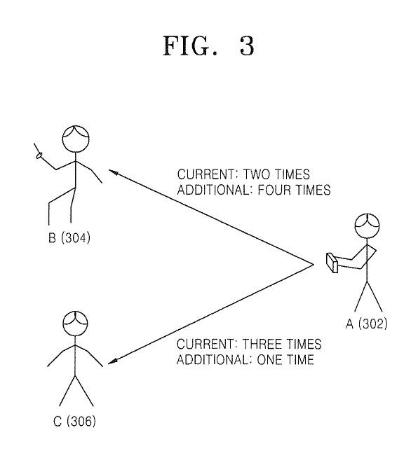

FIG. 3 is a diagram for explaining an example of changing interest values when an online activity of the user A 202 of FIG. 2 is added.

Referring to FIG. 3, since the total sum of interest values that one user may have for each connection step is 1 as in FIG. 2, when an activity (in this case, a clicks number) is added, interest values are changed to 1/accumulated activity numbers.

For example, when already completed clicks numbers are two and three with respect to users B 304 and C 306 who are targets a user A 302 is interested in, an interest value of the user A 302 with respect to the user B 304 is 2/(2+3)=0.4 and an interest value of the user A 302 with respect to the user C 306 is 3/(2+3)=0.6. In this regard, if four clicks are further added with respect to the user B 304 and one click is further added with respect to the user C 306, the interest value of the user A 302 with respect to the user B 304 is changed to (2+4)42+4+3+1)=0.6, and the interest value of the user A 302 with respect to the user C 306 is changed to (3+1)I(2+4+3+1)=0.4.

TABLE 1

| | Before Change | After Change |
|---|---|---|
| Interest value of A with | 0.4 | 0.6 |
| respect to B | | |
| Interest value of A with | 0.6 | 0.4 |
| respect to C | | |
| Total sum of Interest | 1 | 1 |
| values | | |

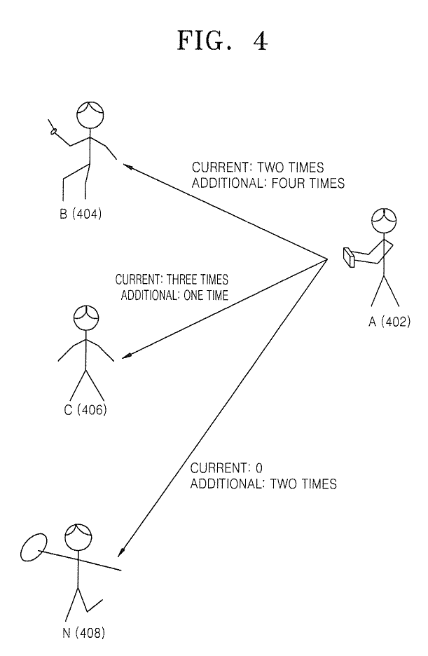

FIG. 4 is a diagram for explaining an example of changing interest values when an online activity with respect to another user of FIG. 3 is added.

Referring to FIG. 4, interest values may change when a new user that is a target of traffic is added due to an additional activity of a user. In this case, for example, interest values with respect to a newly added target are summed in the same manner as in FIG. 3 and then the total sum of the interest values is 1.

For example, when an additional activity (for example, two clicks) with respect to a new user N 408 of the example of FIG. 3 occurs, an interest value of a user A 402 to with respect to a user B 404 is (2+4)42+4+3+1+2)=0.5, an interest value of the user A 402 with respect to a user C 406 is (3+1)/(2+4+3+1+2)=⅓=0.33, and an interest value of a user A 402 with respect to the user N 408 is 2/(2+4+3+1+2)=0.17.

TABLE 2

| | Before Change | After Change |
|---|---|---|
| Interest value of A with | 0.4 | 0.5 |
| respect to B | | |
| Interest value of A with | 0.6 | 0.33 |
| respect to C | | |
| Interest value of A with | — | 0.17 |
| respect to N | | |
| Total sum of Interest | 1 | 1 |
| values | | |

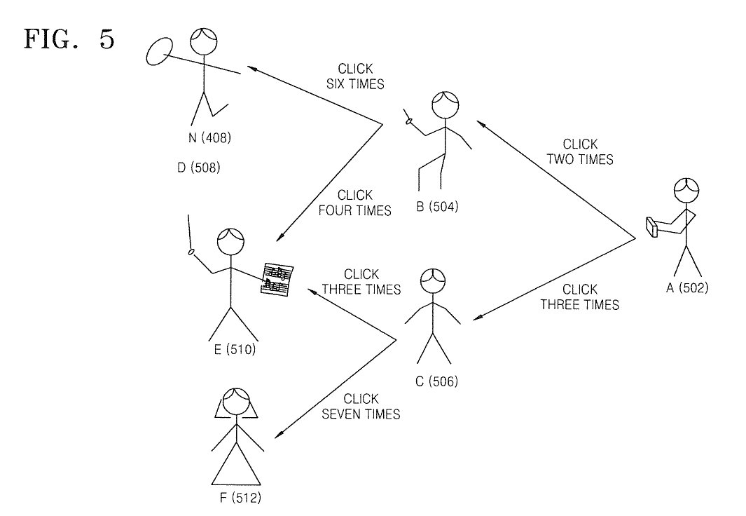

FIG. 5 is a diagram for explaining an example of determining an estimated interest value from a first step interest value.

A method of determining the estimated interest value may have a variety of embodiments. For example, if there is a connection relation of a user A->a user B->a user C and an interest value of the user A with respect to the user B is I_{AB}, the estimated interest value may be determined according to an equation below.

Multiplication I_{AC}=I_{AB}*I_{BC}

Simple sum I_{AC}=I_{AB}+I_{BC}

Simple Difference I_{AC}=I_{BC}−I_{AB}

Arithmetic mean I_{AC}=(I_{AB}+I_{BC})/2

Geometric mean I_{AC}=(I_{AB}*I_{BC})̂(½)

Harmonic mean I_{AC}=(I_{AB}*I_{BC})/(I_{AB}+I_{BC})

Hereinafter, when a “subject” of traffic is A, a “linking user” is B, and a “user linking through the linking user” is C, on the assumption that an interest value with respect to the “user linking through the linking user” is reflected by a proportion of an interest value with respect to the “linking user”, it is calculated that I_{AC}=I_{AB}*I_{BC}.

Referring to FIG. 5, a user B 504 and a user C 506 may express interest values with respect to their respective targets. Also, interest values of the user B 504 with respect to a user D 508 and a user E 510 or interest values of the user C 506 with respect to the user E 510 and a user F 512 may be interest values of the user A 502 complexly. That is, interest values of the user A 502 with respect to the user D 508, the user E 510, and the user F 512 may also be expressed in numeral values.

For example, when an interest value of the user A 502 with respect to the user B 504 is 0.4 and an interest value of the user A 502 with respect to the user C 506 is 0.6, an interest value of the user B 504 with respect to the user D 508 is 0.6 and an interest value of the user B 504 with respect to the user E 510 is 0.4, and an interest value of the user C 506 with respect to the user E 510 is 0.3 and an interest value of the user C 506 with respect to the user F 512 is 0.7, an interest value of the user A 502 with respect to the user D 508 may be expressed as 0.4*0.6=0.24, an interest value of the user A 502 with respect to the user E 510 may be expressed as 0.4*0.4=0.16 or 0.6*0.3=0.16 (or the sum thereof: 0.16+0.18=0.34), and an interest value of the user A 502 with respect to the user F 512 may be expressed as 0.6*0.7=0.42.

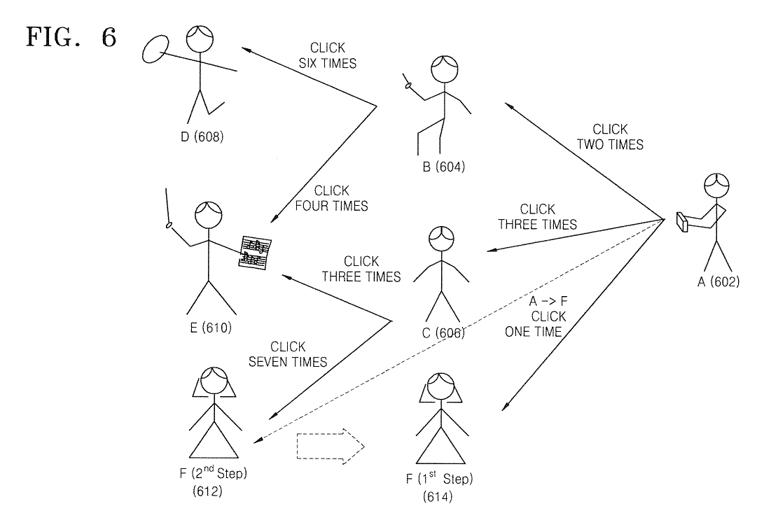

FIG. 6 is a diagram for explaining an example of adding a connection step number with respect to another user of FIG. 5.

Referring to FIG. 6, when an activity of a user A 602 with respect to a user F 612 having a second step connection relation in FIG. 5 is done (for example, when the user A 602 directly clicks a blog of the user F 612 one time), a user F 614 has a first step connection relation with the user A 602.

In this case, interest values of the user A 602 with respect to a user B 604, a user C 606, and the user F 614 are 2/(2+3+1)= 2/6≈33, 3/(2+3+1)= 3/6=0.5, and 1/(2+3+1)≈0.17, respectively.

TABLE 3

| | First step | Second step |
|---|---|---|
| Interest values of A with | 0.42 | 0.17 |
| respect to F | | |

With reference to FIGS. 2 through 6, the method of determining interest values of a first user with respect to second users based on the amount of traffic (for example, clicks) for the first user's access to content associated with the second users was described. However, the interest values of the first user with respect to second users can be determined based on a type of traffic for the first user's access to content associated with the second users. For example, an interest value when the first user visits blogs of the second users one time and an interest value when the first user emails the second users one time may be differently determined. Also, the interest values of the first user with respect to second users can be determined based on a time of traffic for the first user's access to content associated with the second users. For example, an interest value when the first user visits blogs of the second users in the morning and an interest value when the first user emails the second users in the afternoon may be differently determined. Also, for example, an interest value when the first user visits blogs of the second users and stays for one second and an interest value when the first user visits blogs of the second users and stays for one minute may be differently determined.

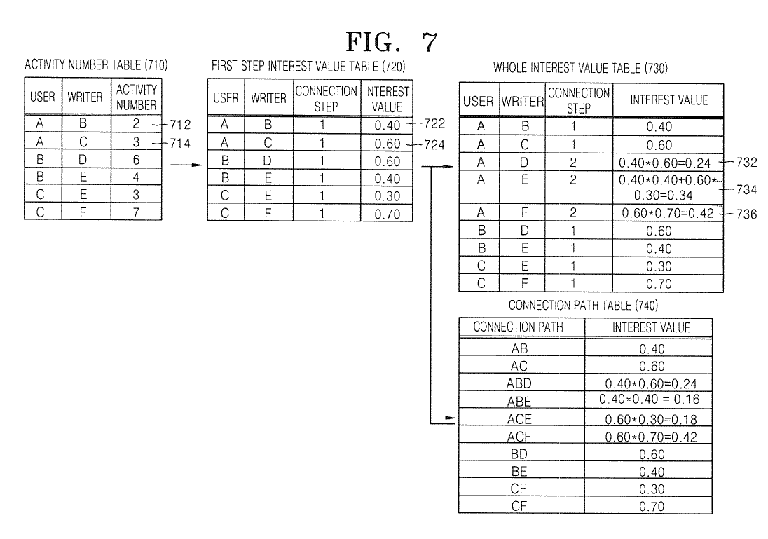

FIG. 7 is a social network table generated by the personalized social network map management apparatus 100 of FIG. 1.

Referring to FIG. 7, the social network table may be, for example, an activity number table 710, a first step interest value table 720, a whole interest value table 730, or a connection path table 740.

The activity number table 710 is generated based on an activity number of a subject using content User (i.e. a first user) with respect to a target using content Writer (i.e. a second user) and is stored in the RAW DB 108 of FIG. 1. For example, an activity number of a user A with respect to a user B is 2 712, and an activity number of the user A with respect to a user C is 3 714.

The first step interest value table 720 includes first step interest values between the subject using content User and the target using content Writer having a direct connection relation with the subject using content User. The first step interest value table 720 is stored in the first step interest value DB 116 of FIG. 1. In this regard, all interest values are the first step interest values, and thus the connection relations are all 1. For example, an interest value of the user A with respect to the user B is 0.40 722, and an interest value of the user A with respect to the user C is 0.60 724.

The whole interest value table 730 includes first step interest values and estimated interest values between the subject using content User and the target using content Writer having direct and indirect connection relations with the subject using content User. Estimated interest values 732, 734, and 736 are determined by the estimated interest and connection path determination unit 120 of FIG. 1. The whole interest value table 730 is stored in the final interest value DB 122.

The connection path table 740 includes connection paths between the subject using content User and the target using content Writer having direct and indirect connection relations with the subject using content User. The connection paths are determined by the estimated interest and connection path determination unit 120 of FIG. 1. The connection path table 740 is stored in the connection path DB 123.

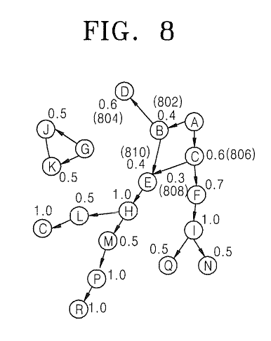

FIG. 8 shows an example of a social network map including first step interest values for each user.

Referring to FIG. 8, links for each user indicate first step interest values between users. For example, a first step interest value of a user A with respect to a user B is 0.4 802, a first step interest value of the user A with respect to a user C is 0.6 806, a first step interest value of the user B with respect to a user D is 0.6 804, and a first step interest value of the user B with respect to a user E is 0.4 810.

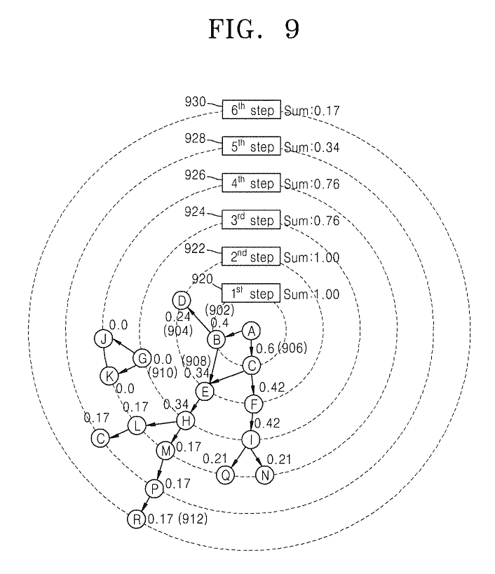

FIG. 9 shows an example of a personalized social network map including first step interest values and estimated interest values from a first step to a sixth step with respect to a specific user A.

Referring to FIG. 9, for example, an interest value (i.e. a first step interest value) of the user A with respect to a user B is 0.4 902, an estimated interest value of the user A with respect to a user D is 0.24 904, a first step interest value of the user A with respect to a user C is 0.6 906, an estimated interest value of the user A with respect to a user E is 0.34 908, and a first step interest value and an estimated interest value of the user A with respect to a user G is 0.0 910.

In this regard, the sum of the first step interest values and the sum of second step estimated interest values of the user A are 1 and are constants, and the sums of third and sixth step estimated interest values are smaller than 1, respectively. This is because steps does not expand in the user D located in the second step, and thus the sum is smaller than 1. The sum in almost all steps has a value closer to 1 in a practical embodiment.

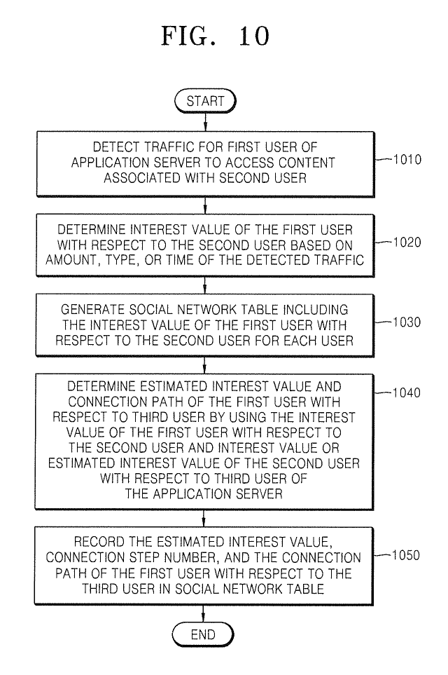

FIG. 10 is a flowchart of a personalized social network map management method in an application server that provides personalized content, according to an embodiment of the present invention.

Referring to FIG. 10, in operation 1010, a personalized social network map management apparatus detects traffic for a first user of an application server to access content associated with a second user of the application server.

In operation 1020, the personalized social network map management apparatus determines an interest value of the first user with respect to the second user based on the amount, type, or time of the traffic detected in operation 1010.

In operation 1030, the personalized social network map management apparatus generates a social network table including the interest value of the first user with respect to the second user for each user.

In operation 1040, the personalized social network map management apparatus determines an estimated interest value and a connection path of the first user with respect to a third user by using the interest value of the first user with respect to the second user and an interest value or an estimated interest value of the second user with respect to a third user of the application server.

In operation 1050, the personalized social network map management apparatus records the estimated interest value, a connection step number, and the connection path of the first user with respect to the third user in a social network table.

Then, the personalized social network map management apparatus may detect other traffic for the first user to access to content associated with content of the third user, determine an interest value of the first user with respect to the third user based on the amount or type of the detected traffic, and record the interest value of the first user with respect to the third user in the social network table. In this regard, the interest value of the first user with respect to the third user and the estimated interest value of the first user with respect to the third user may be recorded in the social network table.

How to utilize the above-described personalized social network map management method will now be described below.

As a first embodiment, a personalized social network map management apparatus may arrange a social network table, for example, with respect to sizes of interest values or estimated interest values of a first user with respect to other users of an application server. Accordingly, the first user may sequentially determine degrees of personal interest in users having direct or indirect connection relations with the first user.

As a second embodiment, the personalized social network map management apparatus may select users by the number of persons previously determined by the first user from other users of the application server, with respect to sizes of interest values or estimated interest values of the first user with respect to other users, and provide the selected users with content associated with the first user. Accordingly, the first user may freely or periodically transmit content desired by other users to other users having high degrees of indirect or direct interest, which is useful to mutual information exchange.

As a third embodiment, the personalized social network map management apparatus may select users by the number of persons previously determined by the first user from other users of the application server, with respect to sizes of interest values or estimated interest values of the first user with respect to other users, and provide the first user with content associated with the selected users. Accordingly, the first user may conveniently receive content of other users having high degrees of indirect or direct interest.

As a fourth embodiment, the personalized social network map management apparatus may arrange a social network table with respect to sizes of interest values or estimated interest values of the first user with respect to other users of an application server. Accordingly, the first user may manifestly determine other users having high degrees of indirect or direct interest in the first user, and determine degrees of interest in the first user from other users.

As a fifth embodiment, the personalized social network map management apparatus may record a connection path of an estimated interest value of the first user with respect to a third user in the social network table, determine an interest value or is the estimated interest value of the first user with respect to the third user, and explore the connection path between the first user and the third user. Accordingly, the first user may discover a connection path to an interested specific user, which helps to contact an acquaintance requiring help in the real world, which adds value to human relations.

The invention can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, etc. The computer-readable recording medium can also be distributed over network-coupled computer systems so that the computer-readable code is stored and executed in a distributed fashion.

While the present invention has been particularly shown and described with reference to exemplary embodiments thereof, it will be understood by one of ordinary skill in the art that various changes in form and details may be made therein without departing from the spirit and scope of the present invention as defined by the following claims.

1. A personalized social network map management method in an application server that provides personalized content, the method comprising:
detecting traffic for a first user of the application server to access content associated with a second user of the application server;
determining an interest value of the first user with respect to the second user based on the amount, type, or time of the detected traffic; and
generating, for each user, a social network table including the interest value of the first user with respect to the second user.

2. The method of claim 1, further comprising:
determining an estimated interest value of the first user with respect to a third is user of the application server by using the interest value of the first user with respect to the second user and an interest value or an estimated interest value of the second user with respect to the third user; and
recording the interest value of the first user with respect to the third user and a connection step number in the social network table.

3. The method of claim 2, further comprising:
detecting other traffic for the first user to access content associated with the third user;
determining an interest value of the first user with respect to the third user based on the amount or type of the detected traffic; and
recording the interest value of the first user with respect to the third user in the social network table,
wherein the interest value of the first user with respect to the third user and the estimated interest value of the first user with respect to the third user are separately recorded in the social network table.

4. The method of claim 2, further comprising: recording a connection path of the interest value of the first user with respect to the second user and a connection path of the estimated interest value of the first user with respect to the third user in the social network table or another social network table separate from the social network table.

5. The method of claim 2, further comprising: arranging the social network tables with respect to sizes of the interest values or the estimated interest values of the first user with respect to the second user and the third user.

6. The method of claim 3, further comprising: arranging the social network tables with respect to sizes of the interest values or the estimated interest values of the first user with respect to the second user and the third user.

7. The method of claim 2, further comprising:
selecting one or more of the second user and the third user with respect to sizes of the interest values or the estimated interest values of the first user with respect to the second user and the third user; and
providing the selected user with content associated with the first user.

8. The method of claim 3, further comprising:
selecting one or more of the second user and the third user with respect to sizes of the interest values or the estimated interest values of the first user with respect to the second user and the third user; and
providing the selected user with content associated with the first user.

9. The method of claim 2, further comprising:
selecting one or more of the second user and the third user with respect to sizes of the interest values or the estimated interest values of the first user with respect to the second user and the third user; and
providing the first user with content associated with the selected user.

10. The method of claim 3, further comprising:
selecting one or more of the second user and the third user with respect to sizes of the interest values or the estimated interest values of the first user with respect to the second user and the third user; and
providing the first user with content associated with the selected user.

11. The method of claim 2, further comprising: arranging the social network tables with respect to sizes of the interest values or the estimated interest values of the first user with respect to the second user and the third user.

12. The method of claim 3, further comprising: arranging the social network tables with respect to sizes of the interest values or the estimated interest values of the first user with respect to the second user and the third user.

13. The method of claim 4, further comprising: exploring the connection path between the first user and the second user or the connection path between the first user and the third user.

14. The method of claim 2, wherein the sum of interest values of the first user with respect to other users of the application server is constant, and the sum of estimated interest values of the first user for each step is smaller than or equal to the constant.

15. The method of claim 3, wherein the sum of interest values of the first user with respect to other users of the application server is constant, and the sum of estimated interest values of the first user for each step is smaller than or equal to the constant.

16. The method of claim 1, wherein the traffic occurs by an online activity including at least one of clicking, seeing documents, visiting, making friends, deleting friends, chatting, emailing, calling, texting, browsing, adding or deleting favorites, commenting, recommending, passing, editing and sending, scrapping, forwarding, storing, printing content, sharing content, trackback, selecting, releasing, mouseover, referring, and tapping of a touch screen terminal.

17. A computer-readable recording medium storing a program for executing a personalized social network map management method in an application server that provides personalized content, the method comprising:
detecting traffic for a first user of the application server to access content associated with a second user of the application server;
determining an interest value of the first user with respect to the second user based on the amount, type, or time of the detected traffic; and
generating, for each user, a social network table including the interest value of the first user with respect to the second user.
